(19) United States
(12) Patent Application Publication
(10) Pub. No.: US 2016/0188856 A1
(43) Pub. Date: Jun. 30, 2016

(54) AUTHENTICATION DEVICE, AUTHENTICATION METHOD, AND NON-TRANSITORY COMPUTER READABLE MEDIUM

(71) Applicant: FUJI XEROX CO., LTD., Tokyo (JP)

(72) Inventors: Masayoshi MIKI, Kanagawa (JP); Akio OKUIE, Kanagawa (JP); Hirotaka SASAKI, Kanagawa (JP)

(73) Assignee: FUJI XEROX CO., LTD., Tokyo (JP)

(21) Appl. No.: 14/726,678

(22) Filed: Jun. 1, 2015

(30) Foreign Application Priority Data
Dec. 26, 2014 (JP) 2014-266302

(51) Int. Cl. G06F 21/32

(52) U.S. Cl. CPC G06F 21/32

(57) ABSTRACT

An authentication device includes a face image extracting unit that extracts a face image of an operator, a footwear image extracting unit that extracts a footwear image, the footwear image being an image of footwear of the operator, a face authentication unit that performs face authentication based on the face image and a registered face image that is registered in advance, and a footwear authentication unit that performs footwear authentication based on the footwear image and a registered footwear image that is registered in advance. The operator is authenticated based on the result of the face authentication performed by the face authentication unit, and the result of the footwear authentication performed by the footwear authentication unit.

### CROSS-REFERENCE TO RELATED APPLICATIONS

This application is based on and claims priority under 35 USC 119 from Japanese Patent Application No. 2014-266302 filed Dec. 26, 2014.

### BACKGROUND

### Technical Field

The present invention relates to an authentication device, an authentication method, and a non-transitory computer readable medium.

### SUMMARY

According to an aspect of the invention, there is provided an authentication device including a face image extracting unit that extracts a face image of an operator, a footwear image extracting unit that extracts a footwear image, the footwear image being an image of footwear of the operator, a face authentication unit that performs face authentication based on the face image and a registered face image that is registered in advance, and a footwear authentication unit that performs footwear authentication based on the footwear image and a registered footwear image that is registered in advance, in which the operator is authenticated based on a result of the face authentication performed by the face authentication unit, and a result of the footwear authentication performed by the footwear authentication unit.

### BRIEF DESCRIPTION OF THE DRAWINGS

Exemplary embodiment of the present invention will be described in detail based on the following figures, wherein:

FIG. 1 illustrates an example of the configuration of an authentication device according to an exemplary embodiment of the invention;

FIG. 2 illustrates an example of a target apparatus incorporating the authentication device according to the exemplary embodiment;

FIG. 3 is a flowchart illustrating operation of the authentication device according to the exemplary embodiment;

FIG. 4 is a flowchart illustrating an authentication process;

FIG. 5 is a flowchart illustrating a registration process;

FIG. 6 is a flowchart illustrating a feature information extraction process in the case of using an operator's body height as a feature;

FIG. 7 illustrates an example of an image acquired by a first image acquiring unit;

FIGS. 8A and 8B each illustrate a length in an image which corresponds to a person's body height, of which FIG. 8A illustrates a person raising an arm in the air who is shown in the image, and FIG. 8B illustrates a length in the image corresponding to the body height of the person illustrated in FIG. 8A;

FIG. 9 is a flowchart illustrating a feature information extraction process in the case of using the color of operator's shoes as a feature;

FIG. 10 is a flowchart illustrating a feature information extraction process in the case of using an operator's action as a feature;

FIGS. 11A and 11B each illustrate an example of a person's action recognized by a feature information detector, of which FIG. 11A illustrates a motion of an arm, and FIG. 11B illustrates a position of a hand;

FIGS. 12A and 12B each illustrate another example of a person's action recognized by the feature information detector, of which FIG. 12A illustrates a motion of an arm, and FIG. 12B illustrates a position of a hand;

FIGS. 13A and 13B each illustrate still another example of a person's action recognized by the feature information detector, of which FIG. 13A illustrates a motion of an arm, and FIG. 13B illustrates a position of a hand;

FIG. 14 illustrates an example of an interface used to register a face image in a registration process;

FIG. 15 illustrates another example of an interface used to register a face image in a registration process;

FIG. 16 illustrates a still another example of an interface used to register a face image in a registration process; and

FIG. 17 illustrates an example of the hardware configuration of an authentication device.

### DETAILED DESCRIPTION

Hereinafter, an exemplary embodiment of the invention will be described in detail with reference to the attached figures.

An authentication device according to the exemplary embodiment is applicable to authentication performed in various scenes by using an image of a user. The description below is directed to a case in which the authentication device according to the exemplary embodiment is incorporated in a specific apparatus (to be referred to as target apparatus hereinafter), and used to authenticate a person (user) who has the authority for using the target apparatus.

<System Configuration>

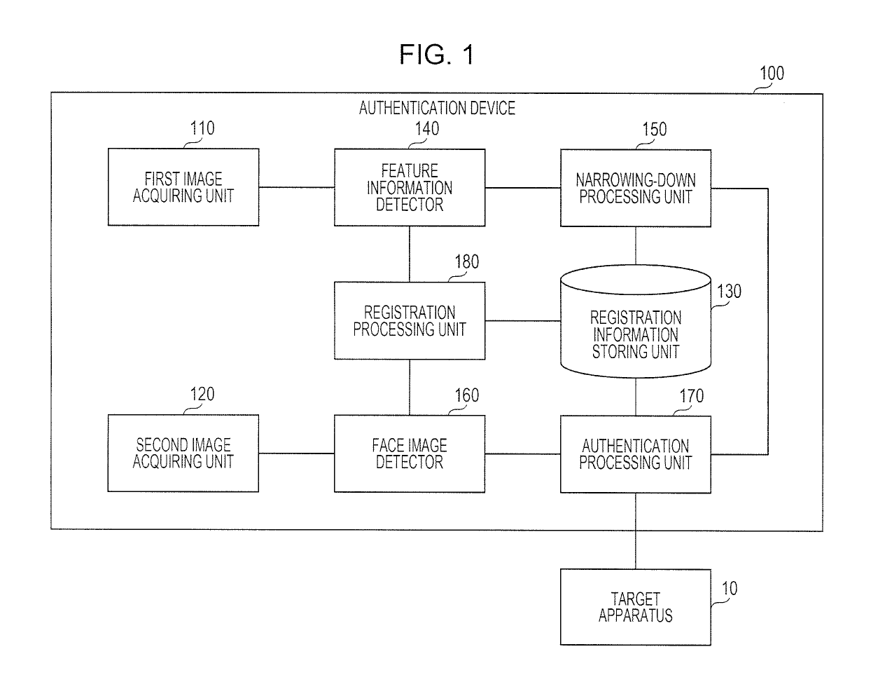

FIG. 1 illustrates an example of the configuration of an authentication device according to the exemplary embodiment.

An authentication device 100 illustrated in FIG. 1 is incorporated in a target apparatus 10. As illustrated in FIG. 1, the authentication device 100 according to the exemplary embodiment includes a first image acquiring unit 110, a second image acquiring unit 120, a registration information storing unit 130, a feature information detector 140, a narrowing-down processing unit 150, a face image detector 160, an authentication processing unit 170, and a registration processing unit 180.

The first image acquiring unit 110 is an image capturing unit for acquiring an image of a specific range. The first image acquiring unit 110 is positioned so as to capture, within its image capture range, a person who is present near the target apparatus 10, particularly a person who is approaching the target apparatus 10 to use the target apparatus 10. For example, the first image acquiring unit 110 is provided on the side of the housing of the target apparatus 10 where the user stands when operating the target apparatus.

The second image acquiring unit 120 is an image capturing unit for acquiring an image of a specific part of the body of an operator who operates the target apparatus 10. The exemplary embodiment uses a face as an example of a specific part of a person's body. Accordingly, the second image acquiring unit 120 is positioned so as to capture the face of a person attempting to operate the target apparatus 10. For example, the second image acquiring unit 120 is located near an operating unit of the target apparatus 10. This makes it easier to capture the face of the operator attempting to look at the operating unit to operate the target apparatus 10.

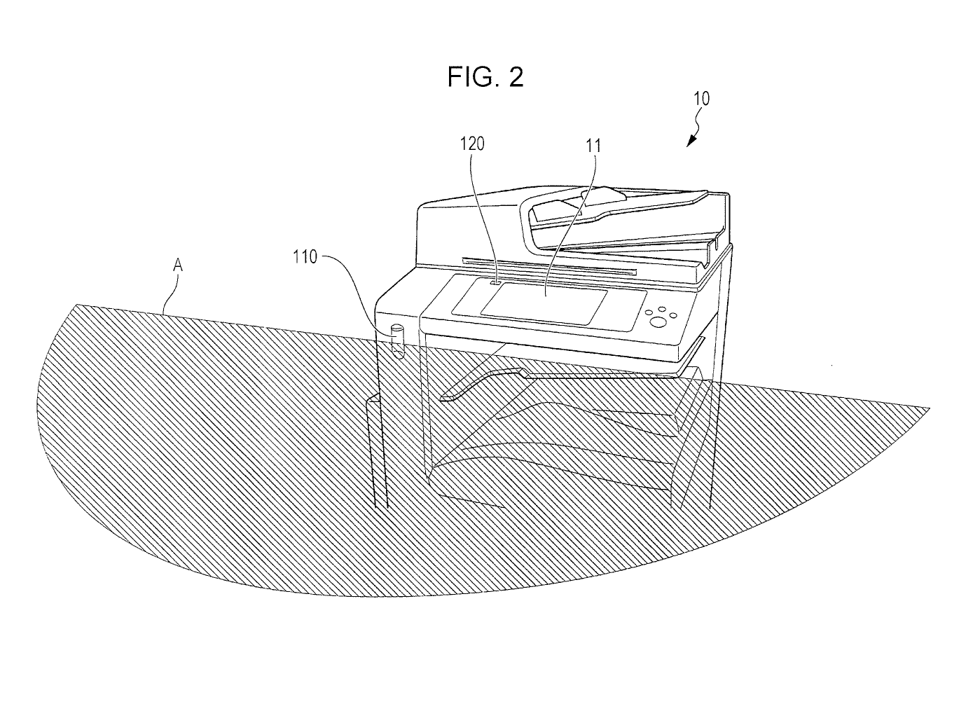

FIG. 2 illustrates an example of the target apparatus 10 incorporating the authentication device 100 according to the exemplary embodiment.

FIG. 2 illustrates an example in which a multi-function machine is used as the target apparatus 10. A multi-function machine refers to an image processing apparatus having functions such as image output, image reading, and image data transmission. The target apparatus 10 illustrated in FIG. 2 is provided with an operation panel 11. The operation panel 11 is used for the operator to perform operations such as making settings on the target apparatus 10 and indicating an action to the target apparatus 10.

The first image acquiring unit 110 is provided on the front side (the side where the user stands when operating the target apparatus) of the target apparatus 10 illustrated in FIG. 2. An area A illustrated in FIG. 2 is a conceptual representation of an area captured by the first image acquiring unit 110. In the example illustrated in FIG. 2, the area A represents a plane taken horizontally at the position where the first image acquiring unit 110 is installed, within the area captured by the first image acquiring unit 110. The actual area to be captured is a three-dimensional area including the area A illustrated in FIG. 2 and extending also in the height direction. Further, the area A illustrated in FIG. 2 represents a range located within a predetermined distance from the first image acquiring unit 110. However, this is merely intended to illustrate the range captured by the first image acquiring unit 110 in a manner that is visually easy to understand. In actuality, the limit range that may be recognized varies depending on factors such as the resolution of the first image acquiring unit 110 and outward appearance features (such as size, shape, and color) of the object being recognized.

The second image acquiring unit 120 is provided near the operation panel 11 of the target apparatus 10 illustrated in FIG. 2. The second image acquiring unit 120 captures the face of the operator who is looking down at the operation panel 11 to operate the target apparatus 10, and acquires a face image of the operator.

The registration information storing unit 130 is a database (DB) in which information used for authentication (authentication information) is registered and stored. In the exemplary embodiment, face images and feature information are used as information for use in authentication. The registration information storing unit 130 stores a face image and feature information in association with each other for each person (registered operator) who is registered as an authorized operator of the target apparatus 10. Feature information refers to information about a predetermined outward appearance feature extracted from an image of a person. Information that may be acquired from the whole body image of a person is set as the feature information. Specifically, for example, the body height, the color or shape of shoes (footwear), the color of clothing, or a characteristic gesture may be set as a feature.

The authentication device 100 according to the exemplary embodiment first narrows down registration information used for authentication, which is stored in the registration information storing unit 130, based on an image of a person who is present near the target apparatus 10 (a person who is a potential operator) which is acquired by the first image acquiring unit 110. Then, the authentication device 100 performs authentication by matching a face image of the operator acquired by the second image acquiring unit 120 against the registration information that has been narrowed down.

The feature information detector 140 detects feature information from the image acquired by the first image acquiring unit 110. As mentioned above, feature information refers to information about a predetermined feature. Feature information detected from an image by the feature information detector 140 is not limited to one kind of information. Multiple different kinds of feature information may be acquired. A specific method of extracting feature information will be described later.

The narrowing-down processing unit 150 narrows down the registration information to target registration information against which authentication is to be performed, based on the feature information detected by the feature information detector 140. That is, the narrowing-down processing unit 150 searches the registration information storing unit 130 based on the detected feature information, and acquires registration information whose feature information corresponds to the detected feature information. Specifically, for example, if the feature information is the body height of the operator, the narrowing-down processing unit 150 selects, as target registration information, any registration information having feature information for which the difference from the body height of the person existing near the target apparatus 10 detected by the feature information detector 140 falls within a predetermined range. Further, if the feature information is the color of the shoes, the narrowing-down processing unit 150 selects, as target registration information, any registration information having feature information that matches the color of the shoes of the person existing near the target apparatus 10 detected by the feature information detector 140.

The face image detector 160 detects a face image of the operator from the image acquired by the second image acquiring unit 120. The method for detecting a face image by image analysis is not particularly limited, and existing techniques may be employed. The face image detector 160 is an example of a specific image detector that detects an image of a specific body part of the operator from the image acquired by the second image acquiring unit 120.

The authentication processing unit 170 performs an authentication process by using the face image detected by the face image detector 160. Specifically, the authentication processing unit 170 matches the face image detected by the face image detector 160 (to be referred to as detected face image hereinafter), against each face image in the registration information stored in the registration information storing unit 130 (to be referred to as registered face image hereinafter). If the similarity between a given registered face image and the detected face image is higher than or equal to a predetermined reference value, the authentication processing unit 170 determines that the registered face image and the detected face image correspond to each other. As a result, the operator from whom the detected face image has been acquired is authenticated to be a registered operator identified by the registered face image. In the exemplary embodiment, the method of performing face image matching is not particularly limited, and existing techniques that compare feature points on faces to determine the similarity between face images may be used.

In the exemplary embodiment, the authentication processing unit 170 first matches a face image against each face image in the registration information narrowed down by the narrowing-down processing unit 150. As mentioned above, at this point, the narrowing-down processing unit 150 has narrowed down the target registration information based on an outward appearance feature of the person. Accordingly, if an operator from whom a detected face image has been acquired is a registered operator, it is highly likely that this operator corresponds to a registered operator identified based on the registration information narrowed down by the narrowing-down processing unit 150. When matching is performed against each registered face image narrowed down by the narrowing-down processing unit 150 in this way, even if the amount of registration information increases, authentication is performed against limited target registration information, thereby minimizing an increase in the time necessary for the processing.

In the exemplary embodiment, if matching of a detected face image against each registered face image narrowed down by the narrowing-down processing unit 150 does not result in detection of any registered face image corresponding to the detected face image, the authentication processing unit 170 performs matching of the face image against all the other pieces of registration information. That is, matching is performed against each piece of registration information which has been excluded from the target registration information by the narrowing down in the narrowing-down processing unit 150. As a result, the authentication process is performed against all the pieces of registration information as targets, thus preventing omissions in the authentication process.

When the matching of the detected face image against each registered face image that is excluded from the target registration information by the narrowing down in the narrowing-down processing unit 150 results in detection of any registered face image corresponding to the detected face image, this means that the feature information detector 140 has detected, from an image including a registered operator, feature information different from the feature information included in the registration information of the registered operator. Accordingly, the authentication processing unit 170 updates the feature information of the registration information including the registered face image corresponding to the detected face image, by the feature information detected by the feature information detector 140.

In this regard, feature information may be updated by one of the following methods: changing previously registered feature information to new feature information; and adding new feature information to previously registered feature information. Which one of the two methods is to be used for updating feature information may be set in accordance with the intended use of the authentication device 100 or the kind of feature information. As an example, the following describes a case where this setting is determined in accordance with the kind of feature information. For example, a case is considered in which the body height of the operator is used as feature information. Because the body height of the operator does not change very much within a short period of time, detection of different feature information is likely to indicate that the feature information included in the corresponding registration information is incorrect. Accordingly, in this case, the feature information (the value of the operator's body height) in the registration information is changed to the newly acquired feature information. In contrast, if the color of operator's shoes is used as feature information, it is possible that totally different pieces of feature information are detected for the same operator for reasons such as the operator buying new shoes or switching between multiple shoes. Accordingly, in this case, newly acquired feature information (shoes color) is added to registration information. In the case of updating registration information by adding feature information, the values (for example, shoes colors) that may be added may be limited to, for example, three.

The registration processing unit 180 newly registers authentication information of the operator. Specifically, the registration processing unit 180 associates a face image detected by the face image detector 160 (detected face image) with feature information detected by the feature information detector 140 for the operator whose face image has been acquired, and stores the resulting information into the registration information storing unit 130 as authentication information. At this time, the registration processing unit 180 may receive an input of information used for identifying the operator such as an ID number or password, and store this information into the registration information storing unit 130 as authentication information together with the feature information and the face image.

In other words, the exemplary embodiment performs authentication of an operator based on a face image of the operator and an image of a feature of the operator. That is, if the body height of the operator is used as a feature, the feature information detector 140 functions as a whole body image extracting unit that extracts an image of the whole body of the operator. The authentication processing unit 170 performs authentication of the operator based on this whole body image and a face image extracted by the face image detector 160. Likewise, if the shape or color of the shoes of an operator is used as a feature, the feature information detector 140 functions as a footwear image extracting unit that extracts an image of footwear of the operator. The authentication processing unit 170 performs authentication of the operator based on this footwear image and a face image extracted by the face image detector 160.

<Operation of Authentication Device>

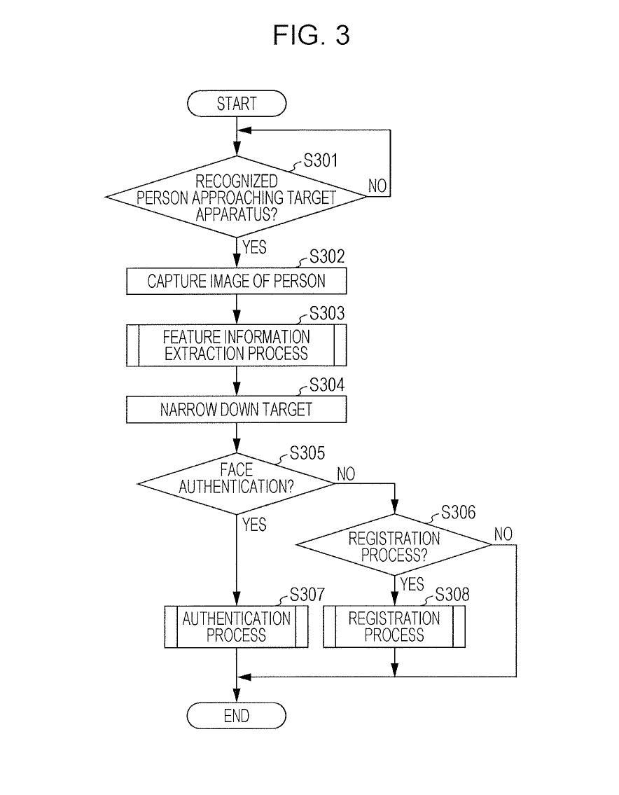

FIG. 3 is a flowchart illustrating operation of the authentication device 100 according to the exemplary embodiment.

As illustrated in FIG. 3, upon recognizing a person approaching the target apparatus 10 (S301), the authentication device 100 has an image of the person captured by the first image acquiring unit 110 (S302). At this time, the person approaching the target apparatus 10 may be recognized by analysis of the image acquired by the first image acquiring unit 110, or by a sensor or the like provided in the target apparatus 10.

Next, the feature information detector 140 performs a feature information extraction process (S303). That is, the feature information detector 140 extracts feature information by analyzing the image acquired by the first image acquiring unit 110. Details of the feature information extraction process will be described later. Once feature information is extracted, next, the narrowing-down processing unit 150 narrows down registration information stored in the registration information storing unit 130 to target registration information (S304). At this point, it is unknown whether the person who has approached the target apparatus 10 is attempting to perform face authentication or registration of authentication information. Accordingly, in the exemplary embodiment, narrowing down of registration information is performed in advance at this point to deal with the case where face authentication is performed later.

Next, the authentication device 100 determines whether to perform face authentication (S305). For example, it is determined to perform face authentication if the operator has performed an operation for logging in to the target apparatus 10. If face authentication is not to be performed (NO in S305), the authentication device 100 determines whether to perform a registration process (S306). For example, it is determined to perform new registration of authentication information if the operator has performed an operation for registering authentication information with the target apparatus 10. The specific condition for determining whether to perform face authentication, or whether to perform registration of authentication information may be set on a case by case basis based on factors such as the type, configuration, specifications, and intended use of the target apparatus 10, and the condition in which the authentication device 100 is installed. For example, the condition may be such that face authentication is performed when no operation takes place, and registration of authentication information is performed only when an operation for registering authentication information is performed.

If the authentication device 100 determines to perform face authentication (YES in S305), the authentication processing unit 170 performs an authentication process by using a detected face image detected by the face image detector 160, and each registered face image included in the registration information narrowed down by the narrowing-down processing unit 150 (S307). If the authentication device 100 determines to perform registration of authentication information (NO in S305, YES in S306), the registration processing unit 180 performs the registration process by using a detected face image detected by the face image detector 160, and feature information detected by the feature information detector 140 (S308).

If the authentication device 100 determines to perform neither face authentication nor registration of authentication information (NO in S305, NO in S306), the processing in the authentication device 100 ends with neither an authentication process nor registration process being performed. How the target apparatus 10 operates in this case is set based on factors such as the type, configuration, specifications, and intended use of the target apparatus 10. For example, the target apparatus 10 may not accept any operation from the operator, or may offer only those pre-set functions which are provided to unregistered operators.

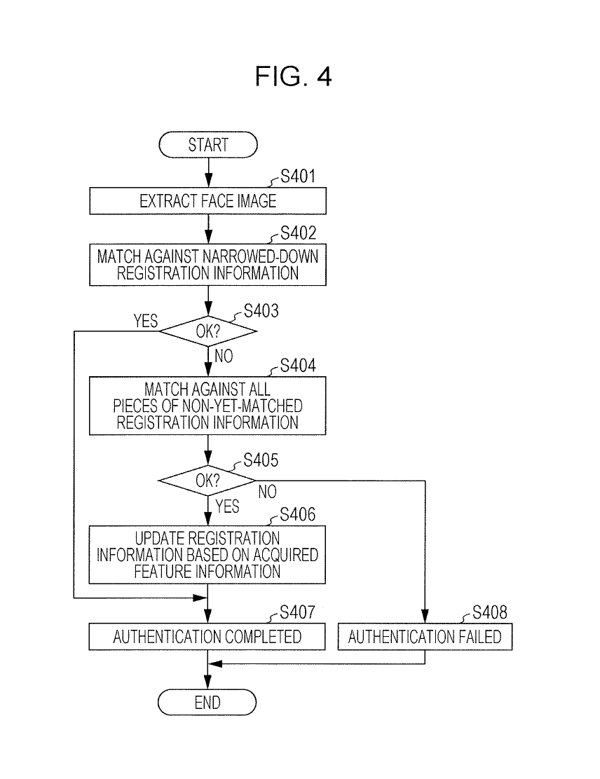

FIG. 4 is a flowchart illustrating an authentication process.

As illustrated in FIG. 4, when an authentication process is started, the face image detector 160 extracts a face image from an image acquired by the second image acquiring unit 120 (S401). At this time, the extraction of a face image may not necessarily be performed after waiting for any particular active operation from the operator. For example, the face image detector 160 may constantly or periodically analyze images continuously acquired by the second image acquiring unit 120, and transmit a detected face image to the authentication processing unit 170 on the condition that the authentication device 100 determines to perform face authentication.

By using the detected face image extracted by the face image detector 160, the authentication processing unit 170 matches the detected face image against each registered face image in the registration information narrowed down by the narrowing-down processing unit 150 (S402). If it is determined as a result of the matching that the detected face image corresponds to any registered face image (OK) (YES in S403), the authentication processing unit 170 notifies the target apparatus 10 that authentication has completed, and also informs the operator to that effect (S407).

If it is determined as a result of the matching that the detected face image does not correspond to any registered face image (Error) (NO in S403), the authentication processing unit 170 matches the detected face image against each piece of registration information which has been excluded by the narrowing down in the narrowing-down processing unit 150 (that is, registration information against which matching has not been performed yet) (S404). If it is determined as a result of this matching that the detected face image corresponds to any registered face image (OK) (YES in S405), the authentication processing unit 170 updates the feature information of the corresponding registration information by the feature information detected by the feature information detector 140 (see S303 in FIG. 3) (S406). Then, the authentication processing unit 170 notifies the target apparatus 10 that authentication has completed, and also informs the operator to that effect (S407).

If, upon performing matching against the registration information against which matching has not been performed yet, it is determined that the detected face image does not correspond to any registered face image (Error) (NO in S405), the authentication processing unit 170 notifies the target apparatus 10 that authentication has failed, and also informs the operator to the effect (S408). If authentication has failed, the authentication processing unit 170 may output a message asking the operator whether to perform registration of authentication information, thus prompting the operator to make a decision.

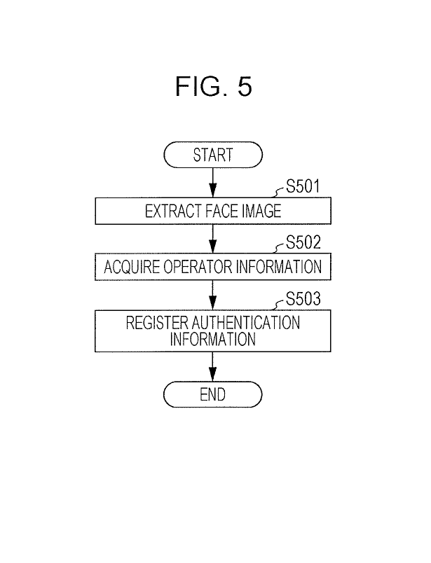

FIG. 5 is a flowchart illustrating a registration process.

As illustrated in FIG. 5, when a registration process is started, the face image detector 160 extracts a face image from an image acquired by the second image acquiring unit 120 (S501). Then, the registration processing unit 180 acquires operator information that is input by the operator to register authentication information (S502). Operator information refers to information for identifying a registered operator. For example, information such as an ID number or password for identifying an operator is used as such operator information. For example, operator information is input by the operator by operating an operating unit (the operation panel 11 in the example illustrated in FIG. 2) of the target apparatus 10.

Upon acquiring the operator information, the registration processing unit 180 associates the acquired operator information, the detected face image extracted by the face image detector 160, and the feature information detected by the feature information detector 140 (see S303 in FIG. 3) with each other, and registers the resulting information into the registration information storing unit 130 as authentication information (S503).

<Feature Information Extraction Process>

Next, the feature information extraction process illustrated as S303 in FIG. 3 will be described.

Feature information used in the exemplary embodiment to narrow down registration information is information about a predetermined feature about the outward appearance of a person which is extracted from an image of the person. Therefore, depending on how to set a feature and feature information, specific details of a feature information extraction process also vary. In other words, specific details of a feature information extraction process are set in accordance with the kind of feature and feature information selected. Hereinafter, specific examples of feature information extraction processes will be described by using examples of features.

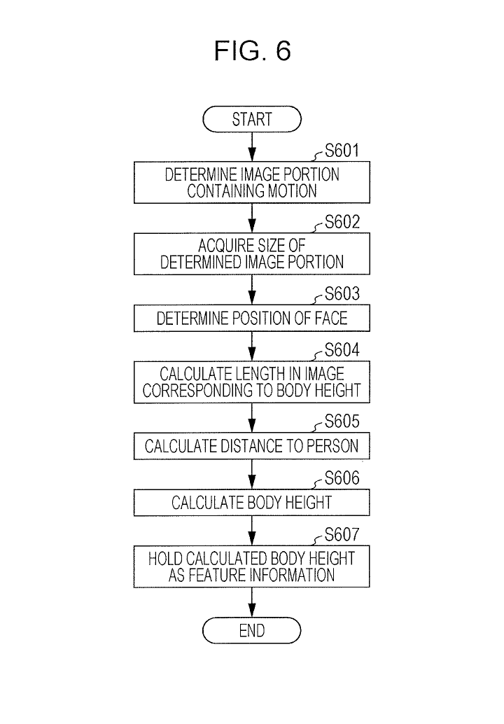

FIG. 6 is a flowchart illustrating a feature information extraction process in the case of using an operator's body height as a feature.

First, the feature information detector 140 determines an image portion that contains motion, from an image acquired by the first image acquiring unit 110 (S601). At this time, an image portion containing motion may be determined by, for example, periodically analyzing images continuously acquired by the first image acquiring unit 110. Specifically, for example, an image acquired at a given point in time is compared with the image acquired immediately before this image, and the portion of the image which differs from the previous image is determined as an image portion containing motion. For example, an image portion containing motion is extracted as a rectangular area within the image acquired by the first image acquiring unit 110.

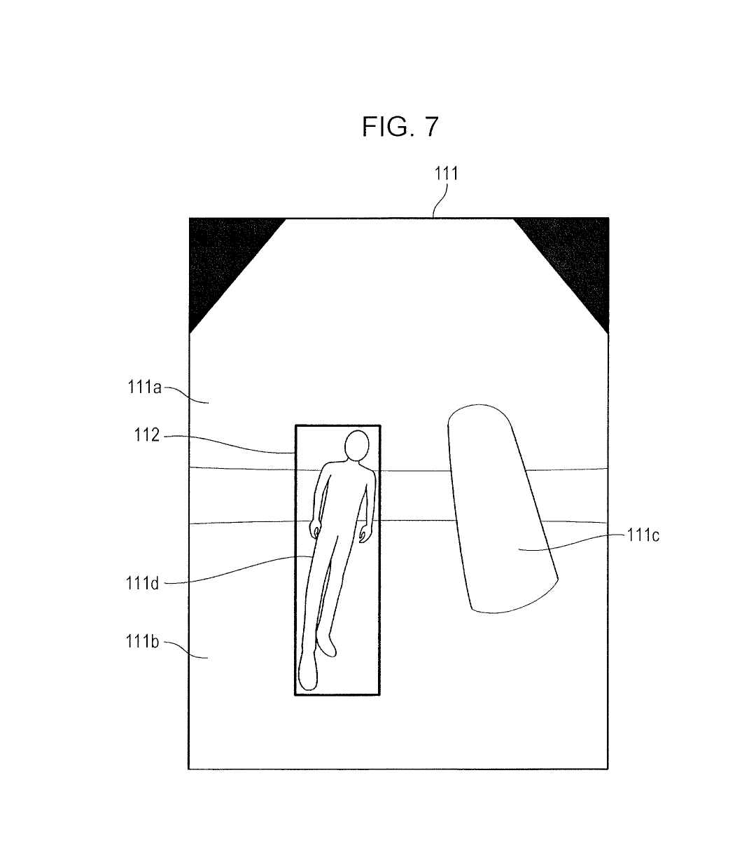

FIG. 7 illustrates an example of an image acquired by the first image acquiring unit 110 (to be referred to as first acquired image hereinafter).

A first acquired image 111 illustrated in FIG. 7 is an example of an image obtained by capturing the space located on the side in front of the target apparatus 10 by the first image acquiring unit 110. A ceiling 111a, a floor 111b, a pillar 111c, and a person 111d are shown in the first acquired image 111. Because the first image acquiring unit 110 has a wide angle of view, these subjects shown in the first acquired image 111 illustrated in FIG. 7 appear distorted from their actual shapes.

Among the subjects in the first acquired image 111 illustrated in FIG. 7, the ceiling 111a, the floor 111b, and the pillar 111c do not move, but the person 111d moves. Accordingly, an image portion containing motion is set in the area of the image where the person 111d is shown. In FIG. 7, an area 112 indicated by a rectangular frame bounding the person 111d represents the image portion containing motion.

Returning to FIG. 6, the feature information detector 140 acquires the size of the area 112 determined as the image portion containing motion (S602). This size represents the size of the area 112 in the first acquired image 111.

Next, the feature information detector 140 identifies a face image from the image included in the area 112, and determines the position of the face image (S603). Identification of a face image may be performed by using existing techniques. Unlike the detection of a face image by the face image detector 160, this face image identification is performed not for the purpose of authentication but only to determine the position of a face. Accordingly, this identification may be performed with just enough accuracy for recognizing the presence of a face.

Next, based on the determined position of the face, the feature information detector 140 calculates a length in the image corresponding to the body height of the person 111d (S604). A length in the image corresponding to the body height of the person 111d refers to the length from the bottom end of the portion of the area 112 where motion is detected (the portion that has a difference from the immediately previous first acquired image 111), to the top end of the position of the face determined in S603.

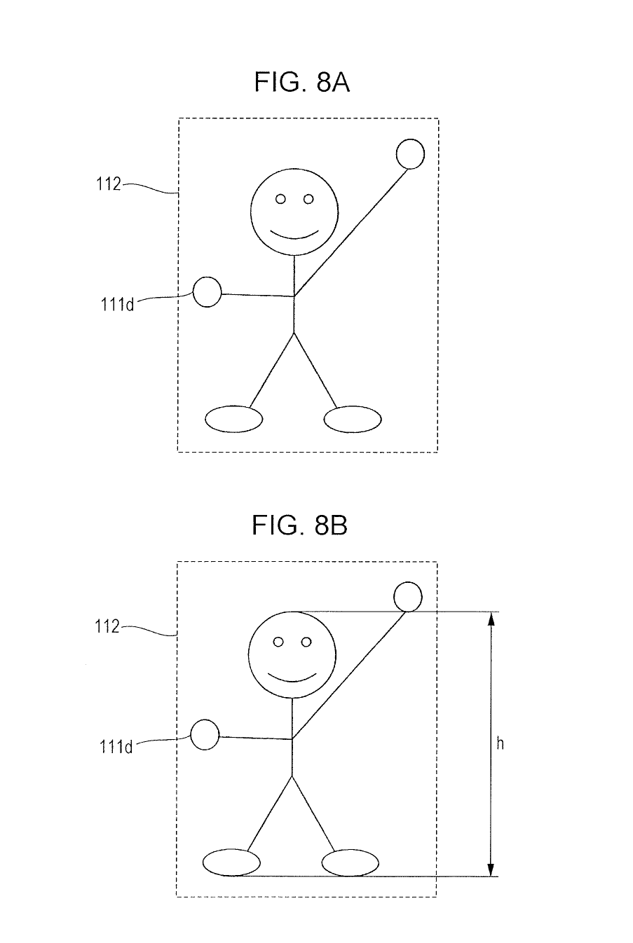

FIGS. 8A and 8B each illustrate a length in an image which corresponds to the body height of the person 111d in the area 112. FIG. 8A illustrates the area 112 where the person 111d raising an arm in the air is shown, and FIG. 8B illustrates a length in the image corresponding to the body height of the person 111d illustrated in FIG. 8A. In FIGS. 8A and 8B, the area 112 is the area bounded by a broken line.

Among various human actions, during actions made with the arm, situations may exist in which the hand is located higher than the head as illustrated in FIG. 8A, owing to the wide range of motion of the arm. Accordingly, the top end of the length corresponding to the body height is not set as the top end of the portion where motion is detected but is set as the top end of the position of the face. In contrast, there are hardly any situations in which another body part is located below the feet while a human is performing an action. Accordingly, the bottom end of the length corresponding to the body height is taken as the bottom end of the portion where motion is detected. In actuality, the position of the bottom end of the portion where motion is detected substantially coincides with the position of the bottom end of the area 112. Therefore, in the example illustrated in FIG. 8B, the length “h” from the bottom end of the portion where motion is detected to the top end of the position of the face represents the length in the image corresponding to the body height of the person 111d.

Next, the feature information detector 140 calculates the actual distance from the first image acquiring unit 110 to the person 111d, based on the position of the bottom end of the area 112 (the bottom end of the portion where motion is detected) in the first acquired image 111 (S605). In the exemplary embodiment, the method of calculating the distance from the first image acquiring unit 110 to the person 111d is not particularly limited, and various existing methods may be used. For example, the distance to a fixed stationary subject (for example, the pillar 111c in FIG. 7) shown in the first acquired image 111 may be registered in advance, and the distance to the person 111d may be calculated based on the positional relationship between the subject and the person 111d. Alternatively, the distance to the person 111d may be calculated based on the state of the optical system of the first image acquiring unit 110 at the time of focusing on the person 111d in the first acquired image 111.

Next, the feature information detector 140 calculates the body height of the person 111d (S606), and holds the value of the calculated body height as feature information for use in various subsequent processes (such as narrowing-down, authentication, and registration processes) (S607). Since the length “h” in the first acquired image 111 corresponding to the body height of the person 111d has been already determined in S604, and the actual distance from the first image acquiring unit 110 to the person 111d is found in S605, the body height of the person 111d is calculated from these values.

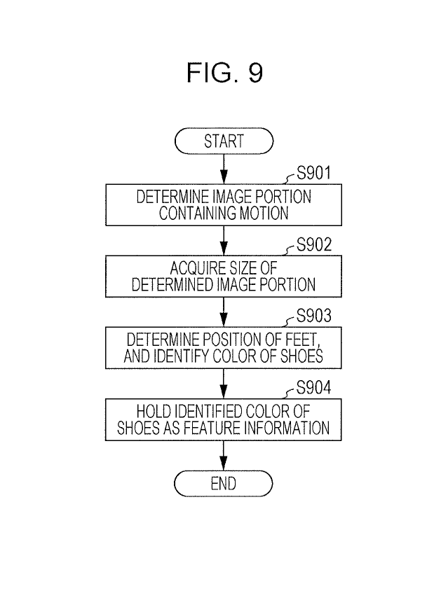

FIG. 9 is a flowchart illustrating a feature information extraction process in the case of using the color of operator's shoes as a feature.

First, the feature information detector 140 determines an image portion that contains motion, from an image acquired by the first image acquiring unit 110 (S901). Then, the feature information detector 140 acquires the size of the area 112 determined as the image portion containing motion (S902). The operation up to this point is the same as S601 and S602 illustrated in FIG. 6.

Next, the feature information detector 140 calculates the position of the feet of the person 111d (S903), identifies the color of the shoes, and holds the identified color of the shoes as feature information for use in various subsequent processes (such as narrowing-down, authentication, and registration processes) (S904). As described above with reference to S604 in FIG. 6, there are hardly any situations in which another body part is located below the feet while a human is performing an action. Accordingly, the bottom end of the portion of the area 112 where motion is detected (the portion that has a difference from the immediately previous first acquired image 111) is regarded as the position of the feet of the person 111d. Further, at this position, if there is any portion that differs in color from the surroundings, this portion is regarded as the shoes. Then, the color of the portion regarded as the shoes (the color of the shoes) is set as feature information.

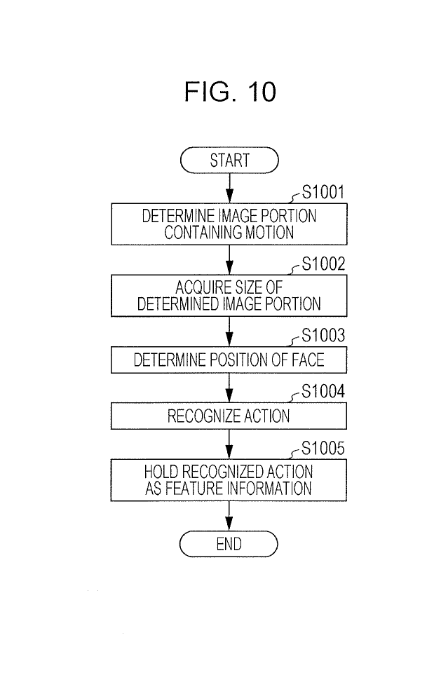

FIG. 10 is a flowchart illustrating a feature information extraction process in the case of using an operator's action as a feature.

First, the feature information detector 140 determines an image portion that contains motion, from an image acquired by the first image acquiring unit 110 (S1001). Then, the feature information detector 140 acquires the size of the area 112 determined as the image portion containing motion (S1002). Then, the feature information detector 140 identifies a face image from the image included in the area 112, and determines the position of the face image (S1003). The operation up to this point is the same as S601 to S603 illustrated in FIG. 6.

Next, the feature information detector 140 recognizes an action of the person 111d (S1004), and holds information about the recognized action as feature information for use in various subsequent processes (such as narrowing-down, authentication, and registration processes) (S1005). Among various actions that may be performed by the person 111d, the exemplary embodiment focuses on motions of the arm or hand which has a wide range of motion. Specifically, for example, the feature information detector 140 recognizes the kind of arm or hand motion, and the position of the hand relative to the position of the face. Recognition of an arm or hand motion by image analysis may be performed by using existing techniques.

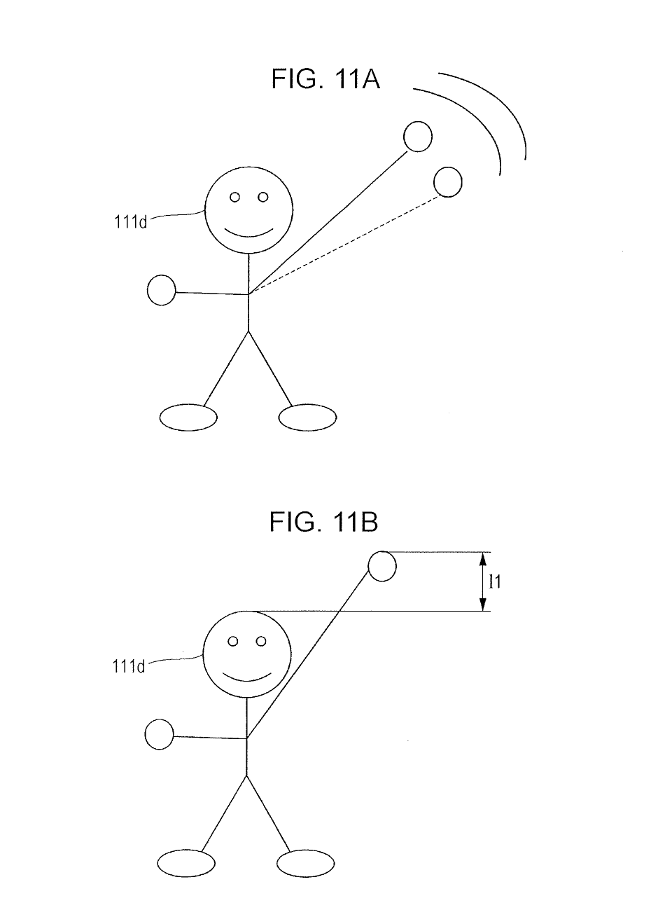

FIGS. 11A and 11B each illustrate an example of an action of the person 111d which is recognized by the feature information detector 140. FIG. 11A illustrates a motion of an arm, and FIG. 11B illustrates a position of a hand.

In the example illustrated in FIG. 11A, the person 111d is making the motion of waving an arm. In the example illustrated in FIG. 11B, at least at some point during the arm motion illustrated in FIG. 11A, the hand is raised higher than the face. The position of the hand at this time may be simply represented as information indicating that the position of the hand is higher than that of the hand, or may be represented as information including the value of height relative to the face (the hand is located higher than the face by a length “11” in the example illustrated in FIG. 11B). In the exemplary embodiment, the arm motion illustrated in FIG. 11A, and the hand position illustrated in FIG. 11B represent feature information.

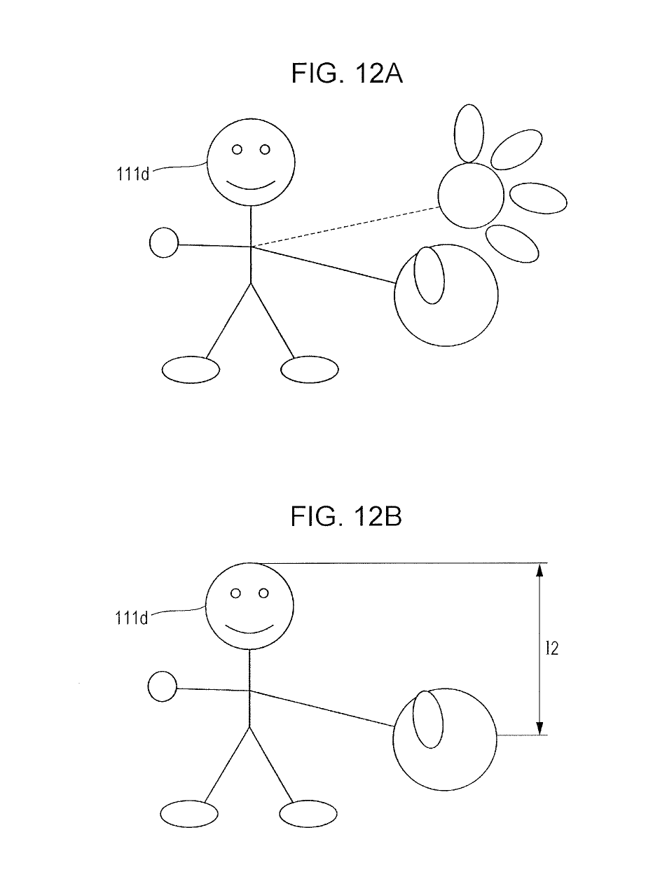

FIGS. 12A and 12B each illustrate another example of an action of the person 111d which is recognized by the feature information detector 140. FIG. 12A illustrates a motion of an arm, and FIG. 12B illustrates a position of a hand.

In the example illustrated in FIG. 12A, the person 111d is making the motion of squeezing a hand into a first and opening the hand while waving an arm. In the example illustrated in FIG. 12B, the motions of the arm and hand illustrated in FIG. 12A are made at a position lower than that of the face. The position of the hand at this time may be simply represented as information indicating that the position of the hand is lower than that of the hand, or may be represented as information including the value of height relative to the face (the hand is located lower than the face by a length “12” in the example illustrated in FIG. 12B). In the exemplary embodiment, the arm motion illustrated in FIG. 12A, and the hand position illustrated in FIG. 12B represent feature information.

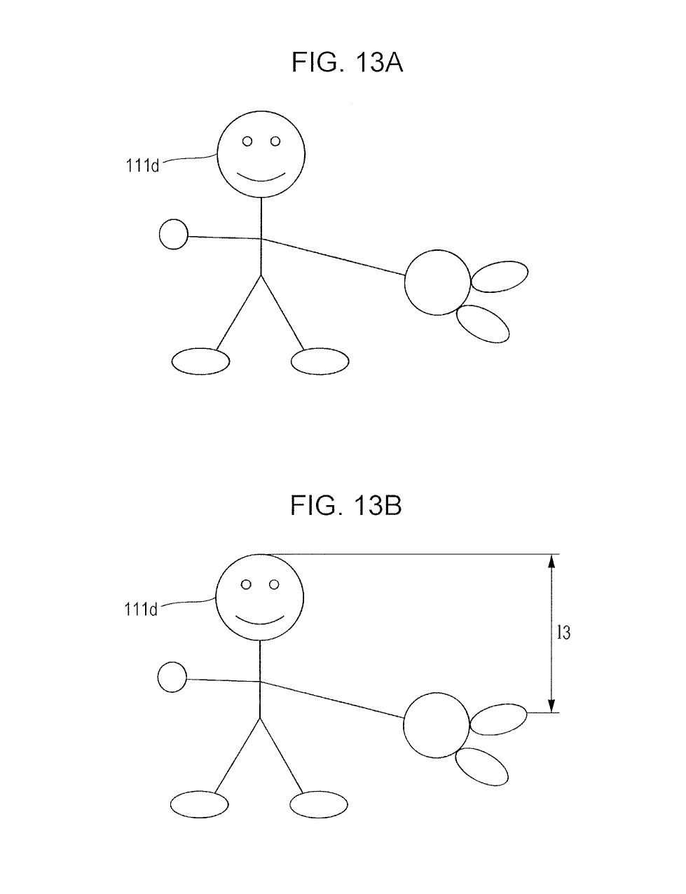

FIGS. 13A and 13B each illustrate still another example of an action of the person 111d which is recognized by the feature information detector 140. FIG. 13A illustrates a motion of an arm, and FIG. 13B illustrates a position of a hand.

In the example illustrated in FIG. 13A, the person 111d is raising several fingers on a hand without waving an arm. In the example illustrated in FIG. 13B, the state of the arm and the hand illustrated in FIG. 13A is maintained at a position lower than that of the face. The position of the hand at this time may be simply represented as information indicating that the position of the hand is lower than that of the hand, or may be represented as information including the value of height relative to the face (the hand is located lower than the face by a length “13” in the example illustrated in FIG. 13B). In the exemplary embodiment, the arm motion illustrated in FIG. 13A, and the hand position illustrated in FIG. 13B represent feature information.

While three kinds of actions that may be extracted as feature information have been described above, the above-mentioned actions are illustrative only, and not intended to limit the actions that may be used as feature information. Further, the specific kinds of feature information illustrated in the feature information extraction processes described above with reference to FIGS. 6 to 13B are only illustrative of examples of information that may be used as feature information in the exemplary embodiment, and not intended to limit the kinds of feature information that may be used.

<Modification of Authentication Process>

In the exemplary embodiment, a face image of an operator is used to authenticate the operator. This face authentication may be combined with authentication using operator information such as an ID number or password. In this case, in addition to performing face authentication, the authentication device 100 requests the operator to input operator information, and performs authentication using the input operator information. Enhanced security is achieved by performing authentication using multiple different measures in this way. As for the measure to perform authentication using operator information, measures implemented in existing authentication systems or the like may be used.

Although the exemplary embodiment places no particular limitation on the kind of face that may serve as a registered face image for use in face authentication, a special condition may be added to such a registered face image. Specifically, for example, a face image with a special facial expression, or an image including an image of a non-face body part such as the hand together with the face is used as a registered face image. Enhanced security is achieved by using a face image with such a special added condition as registration information.

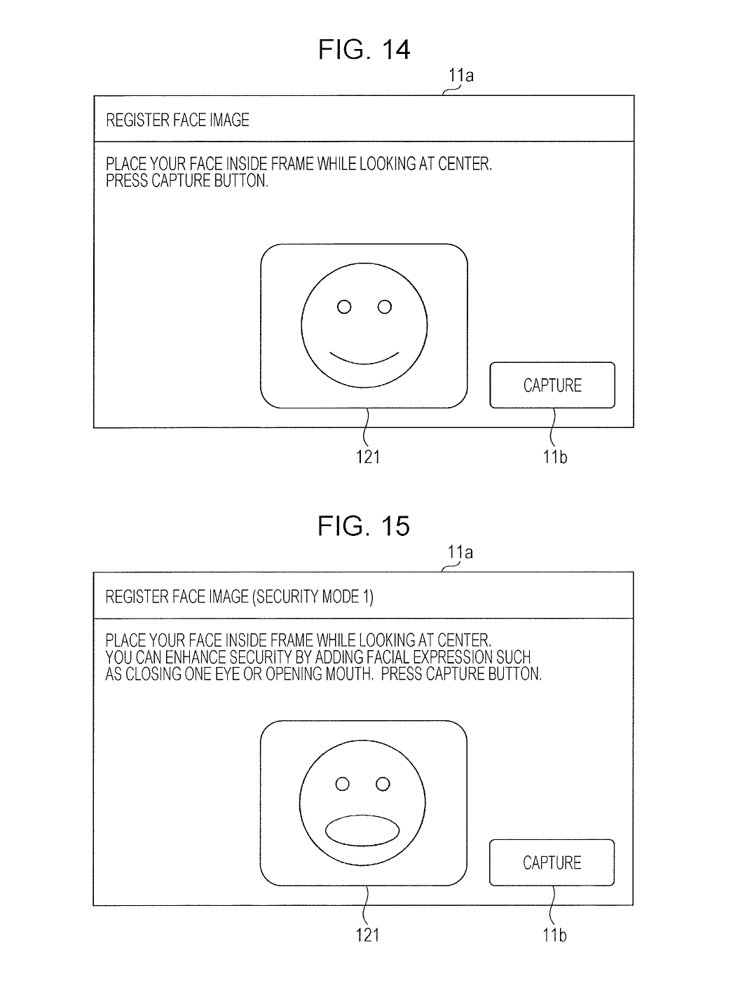

FIG. 14 illustrates an example of an interface used to register a face image in a registration process.

FIG. 14 illustrates an example of an interface using a display unit of the operation panel 11 (see FIG. 2) used as an operating unit of the target apparatus 10. In this example, the operation panel 11 is implemented by a touch panel. A screen 11a related to various operations is displayed on the operation panel 11. The screen 11a illustrated in FIG. 14 is an operation image prepared for registration of a face image. The screen 11a illustrated in FIG. 14 shows an image 121 acquired by the second image acquiring unit 120, and a button object 11b used for the operator to input an instruction to capture an image. Further, the screen 11a shows a message explaining how to capture a face image.

In accordance with the message, the operator adjusts the position or orientation of his/her face while looking at the image 121 displayed on the screen 11a. Then, the operator touches the button object 11b to have an image of the face captured by the second image acquiring unit 120. In S501 of the registration process described above with reference to FIG. 5, a face image is extracted from the image captured at this time. Then, as mentioned above, by changing the facial expression or having an image of a non-face body part included in the captured image at the time of this image capture, a special condition is added to the registered face image. Further, a special condition may be added with respect to the operator at the time of face image capture.

FIG. 15 illustrates another example of an interface used to register a face image in a registration process.

In the example illustrated in FIG. 15, the configuration of the screen 11a is similar to that of the example illustrated in FIG. 14. However, unlike in the example illustrated in FIG. 14, a message advising the operator to add a special facial expression (such as “closing one eye or opening the mouth” in the example illustrated in FIG. 15) is displayed.

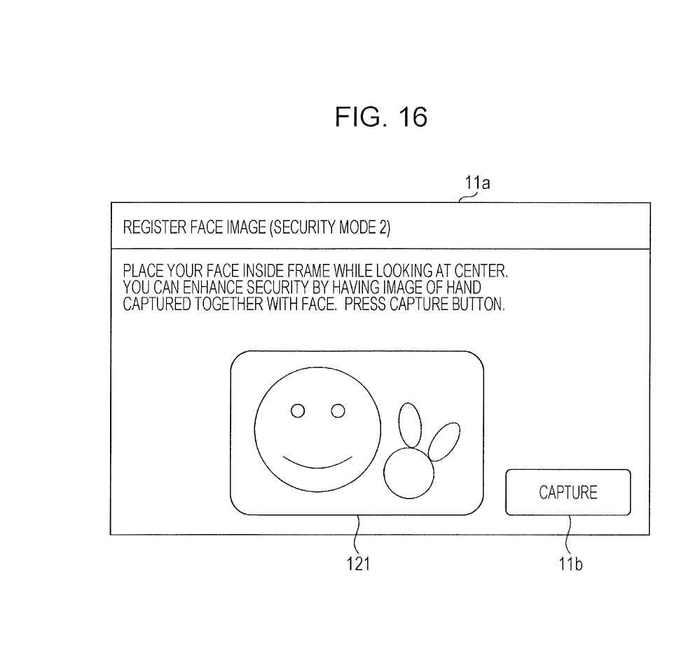

FIG. 16 illustrates still another example of an interface used to register a face image in a registration process.

In the example illustrated in FIG. 16, the configuration of the screen 11a is similar to that of the example illustrated in FIG. 14. However, unlike in the example illustrated in FIG. 14, a message advising the operator to have an image of a non-face body part (a hand in the example illustrated in FIG. 16) captured together with the face is displayed.

<Modification of Authentication Device>

In the exemplary embodiment mentioned above, the authentication device 100 is incorporated in the target apparatus 10. However, the manner of installation of the authentication device 100 is not limited to this. The authentication device 100 may be installed in various manners depending on factors such as the type, configuration, specifications, and intended use of the target apparatus 10. For example, feature information may be extracted by capturing an image of the operator approaching the target apparatus 10 by the first image acquiring unit 110, in the authentication device 100 provided separately from the target apparatus 10. Further, to acquire a face image by the second image acquiring unit 120, the operator may be instructed to turn his/her face toward the second image acquiring unit 120 provided at a position different from the operating unit of the target apparatus 10. Further, while the first image acquiring unit 110 and the second image acquiring unit 120 are provided separately from each other in the exemplary embodiment, the functions of both the first image acquiring unit 110 and the second image acquiring unit 120 may be implemented by the same single image acquiring unit (camera).

Further, while authentication based on a face image is performed in the exemplary embodiment, the exemplary embodiment is also applicable to authentication based on another specific body part that may be used for authentication. For example, the authentication device 100 according to the exemplary embodiment may be directly applied to authentication using a palm print by simply replacing the face image with a palm print image.

<Hardware Configuration of Authentication Device>

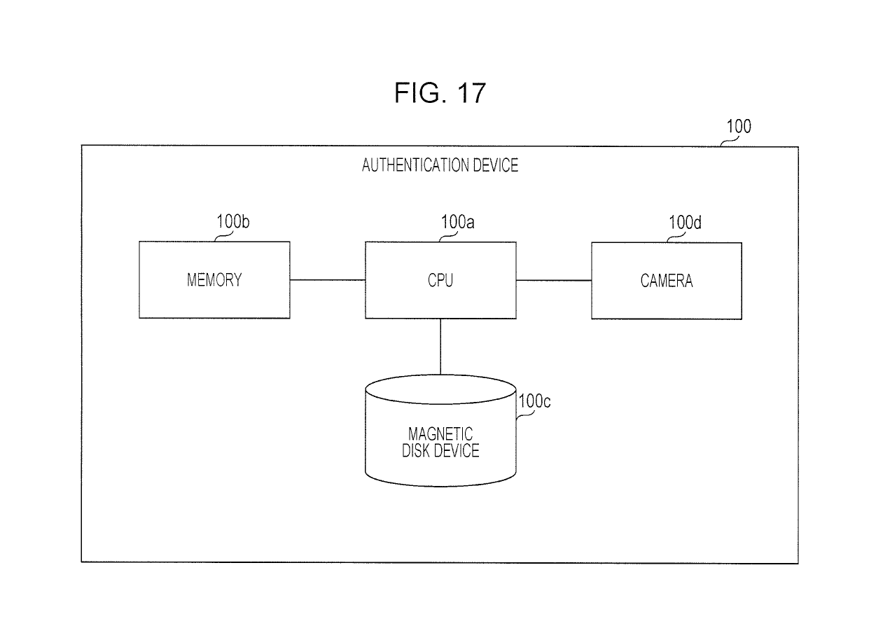

FIG. 17 illustrates an example of the hardware configuration of the authentication device 100.

As illustrated in FIG. 17, the authentication device 100 includes a CPU 100a, a memory 100b, a magnetic disk device (HDD) 100c, and a camera 100d. The magnetic disk device 100c stores a program. This program is developed into the memory 100b. As the program developed into the memory 100b is executed by the CPU 100a, functions corresponding to the feature information detector 140, the narrowing-down processing unit 150, the face image detector 160, and the authentication processing unit 170 of the authentication device 100 are implemented. The memory 100b is also used as a work memory when processes based on these functions are executed. The magnetic disk device 100c, which serves as the registration information storing unit 130 of the authentication device 100, holds registration information. The camera 100d is used as each of the first image acquiring unit 110 and the second image acquiring unit 120. As described above, the first image acquiring unit 110 and the second image acquiring unit 120 may be implemented either by separate cameras 100d or by a single camera 100d.

If the authentication device according to the exemplary embodiment 100 is incorporated in the target apparatus 10 as in the configuration example illustrated in FIG. 2, for example, a processor and a memory in the controller of the target apparatus 10 may be used as the CPU 100a and the memory 100b, respectively. Further, as the magnetic disk device 100c, an auxiliary memory incorporated in the target apparatus 10 may be used. Further, if the target apparatus 10 incorporates a camera, this camera may be used as the camera 100d of the authentication device 100.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An authentication device comprising:
a face image extracting unit that extracts a face image of an operator;
a footwear image extracting unit that extracts a footwear image, the footwear image being an image of footwear of the operator;
a face authentication unit that performs face authentication based on the face image and a registered face image that is registered in advance; and
a footwear authentication unit that performs footwear authentication based on the footwear image and a registered footwear image that is registered in advance,
wherein the operator is authenticated based on a result of the face authentication performed by the face authentication unit, and a result of the footwear authentication performed by the footwear authentication unit.

2. An authentication device comprising:
a first image acquiring unit that acquires an image of a person;
a second image acquiring unit that acquires an image including a specific body part of the person;
a feature information detector that detects information about a feature that is set in advance, from the image acquired by the first image acquiring unit;
a specific image detector that detects an image of the specific body part of the person from the image acquired by the second image acquiring unit;
a registration information storing unit that stores registration information, the registration information associating information about the feature of a registered person with an image of the specific body part of the registered person;
a narrowing-down processing unit that narrows down the registration information stored in the registration information storing unit, to the registration information against which authentication is to be performed, based on the information about the feature detected by the feature information detector; and
an authentication processing unit that performs authentication by using the registration information narrowed down by the narrowing-down processing unit, and the image of the specific body part detected by the specific image detector.

3. The authentication device according to claim 2,
wherein if the authentication using the registration information narrowed down by the narrowing-down processing unit and the image of the specific body part detected by the specific image detector does not result in detection of the registration information that includes an image corresponding to the image of the specific body part, the authentication processing unit performs authentication by using the registration information excluded by the narrowing down by the narrowing-down processing unit, and the image of the specific body part detected by the specific image detector.

4. The authentication device according to claim 3,
wherein if the authentication using the registration information excluded by the narrowing down by the narrowing-down processing unit and the image of the specific body part detected by the specific image detector results in detection of the registration information that includes an image corresponding to the image of the specific body part, the authentication processing unit updates the information about the feature included in the registration information by the information about the feature detected by the feature information detector.

5. The authentication device according to claim 4,
wherein the authentication processing unit updates the information about the feature included in the registration information by adding the information about the feature detected by the feature information detector.

6. The authentication device according to claim 4,
wherein the authentication processing unit updates the information about the feature included in the registration information by changing the information about the feature included in the registration information to the information about the feature detected by the feature information detector.

7. The authentication device according to claim 3, further comprising a registration processing unit that, if the authentication using the registration information excluded by the narrowing down by the narrowing-down processing unit and the image of the specific body part detected by the specific image detector does not result in detection of the registration information that includes an image corresponding to the image of the specific body part, accepts registration of the registration information that associates the information about the feature detected by the feature information detector with the image of the specific body part detected by the specific image detector, in response to an operation by the operator.

8. The authentication device according to claim 2,
wherein the first image acquiring unit and the second image acquiring unit each comprise a separate camera.

9. A non-transitory computer readable medium storing a program causing a computer to execute a process for performing authentication, the process comprising:
detecting information about a feature that is set in advance, from an image of a person acquired by a first image acquiring unit;
detecting an image of a specific body part of the person from an image including the specific body part of the person acquired by a second image acquiring unit;
narrowing down registration information stored in a memory, based on the detected information about the feature, to the registration information against which authentication is to be performed, the registration information associating information about the feature of a registered person with an image of the specific body part of the registered person; and
performing authentication by using the narrowed-down registration information and the detected image of the specific body part.

10. An authentication method comprising:
detecting information about a feature that is set in advance, from an image of a person acquired by a first image acquiring unit;
detecting an image of a specific body part of the person from an image including the specific body part of the person acquired by a second image acquiring unit;
narrowing down registration information stored in a memory, based on the detected information about the feature, to the registration information against which authentication is to be performed, the registration information associating information about the feature of a registered person with an image of the specific body part of the registered person; and
performing authentication by using the narrowed-down registration information and the detected image of the specific body part.
